(19) United States
(12) Patent Application Publication
(10) Pub. No.: US 2017/0249102 A1
(43) Pub. Date: Aug. 31, 2017

(54) INFORMATION PROCESSING APPARATUS

(71) Applicant: Kabushiki Kaisha Toshiba, Minato-ku (JP)

(72) Inventors: Kenichi MAEDA, Kamakura (JP); Kenji FUNAOKA, Kawasaki (JP); Reina NISHINO, Yokohama (JP); Nobuhiro KONDO, Yokohama (JP); Toshio FUJISAWA, Yokohama (JP)

(73) Assignee: Kabushiki Kaisha Toshiba, Minato-ku (JP)

(21) Appl. No.: 15/258,179

(22) Filed: Sep. 7, 2016

Related U.S. Application Data
(60) Provisional application No. 62/301,073, filed on Feb. 29, 2016.

(51) Int. Cl. G06F 3/06; G06F 1/26

(52) U.S. Cl. CPC G06F 3/0656; G06F 3/061; G06F 3/0685; G06F 1/26

(57) ABSTRACT

According to one embodiment, an information processing apparatus includes a host device, a memory system and a power supply circuit. The host device includes a volatile first memory and a first control circuit. The memory system includes a non-volatile second memory in which user data is stored and a second control circuit. The second control circuit executes transfer of the user data between the host device and the second memory. The first memory includes an area used by the second control circuit. The second control circuit uses the area as a buffer for the transfer. The first control circuit causes the power supply circuit to start and stop the power supply to the memory system. The first control circuit accesses, while the power supply to the memory system is stopped, the buffer.

### CROSS-REFERENCE TO RELATED APPLICATIONS

This application is based upon and claims the benefit of priority from U.S. Provisional Application No. 62/301,073, filed on Feb. 29, 2016; the entire contents of which are incorporated herein by reference.

### FIELD

Embodiments described herein relate generally to an information processing apparatus.

### BACKGROUND

Conventionally, as memory architecture of an information processing apparatus provided with a host device (hereinafter, simply, a host) and a memory system that is an external storage device of the host, unified memory architecture (UMA) is known. The UMA is memory architecture in which a memory mounted on the host is shared by the host and the memory system. According to the UMA, a decrease in memory cost can be achieved.

### BRIEF DESCRIPTION OF THE DRAWINGS

FIG. 1 is a diagram illustrating a configuration example of an information processing apparatus of a first embodiment;

FIG. 2 is a flowchart illustrating an example of a read operation of the information processing apparatus of the first embodiment;

FIG. 3 is a diagram for describing a flow of data in a case where a logical address is hit in the operation of read of the first embodiment;

FIG. 4 is a diagram for describing data and a flow of a signal in a case where the logical address is not hit in the operation of read of the first embodiment;

FIG. 5 is a flowchart illustrating an example of a write operation of the information processing apparatus of the first embodiment;

FIG. 6 is a diagram illustrating an example of a power mode group;

FIG. 7 is a flowchart illustrating an example of a read operation of an information processing apparatus of a second embodiment;

FIG. 8 is a diagram for describing data and a flow of a signal in a case where a logical address is hit in the operation of read of the second embodiment;

FIG. 9 is a diagram for describing data and a flow of a signal in a case where the logical address is not hit in the operation of read of the second embodiment; and

FIG. 10 is a flowchart illustrating an example of a write operation of the information processing apparatus of the second embodiment.

### DETAILED DESCRIPTION

In general, according to one embodiment, an information processing apparatus includes a host device, a memory system and a power supply circuit. The host device includes a volatile first memory and a first control circuit. The memory system includes a non-volatile second memory in which user data is stored and a second control circuit. The second control circuit executes transfer of the user data between the host device and the second memory. The first memory includes an area used by the second control circuit. The second control circuit uses the area as a buffer for the transfer. The first control circuit causes the power supply circuit to start and stop the power supply to the memory system. The first control circuit accesses, while the power supply to the memory system is stopped, the buffer.

Exemplary embodiments of an information processing apparatus will be explained below in detail with reference to the accompanying drawings. The present invention is not limited to the following embodiments.

### First Embodiment

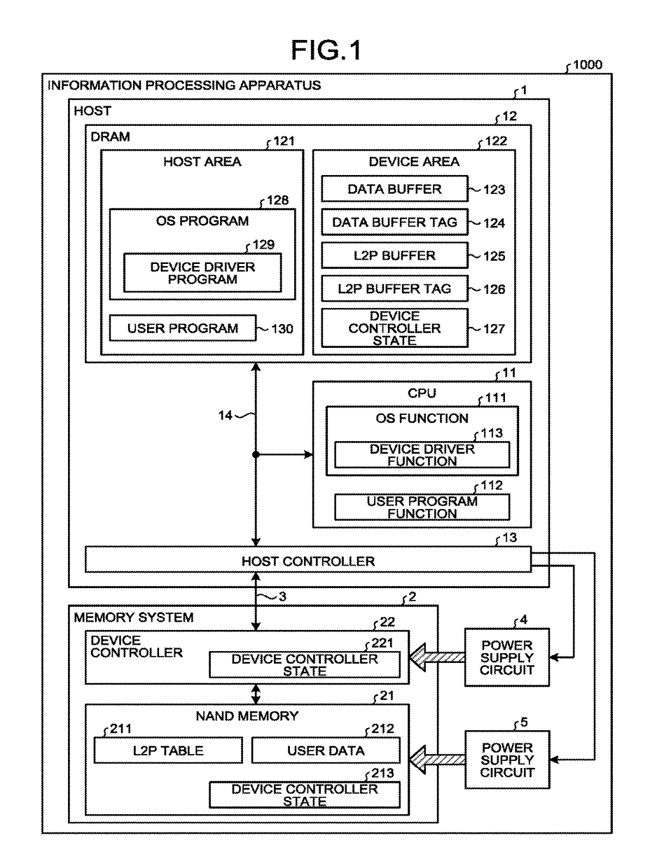

FIG. 1 is a diagram illustrating a configuration example of an information processing apparatus of a first embodiment. An information processing apparatus 1000 includes a host 1 and a memory system 2. The host 1 is a host device of an embodiment. The host 1 and the memory system 2 are connected with a communication path 3. As memory architecture of the information processing apparatus 1000, UMA is employed.

The information processing apparatus 1000 is a server, a personal computer, a mobile phone, an imaging device, or the like. As a standard that the memory system 2 conforms to, a standard of the communication path 3, and a communication standard through the communication path 3, arbitrary standards can be employed. For example, the memory system 2 is a flash memory conforming to a universal flash storage (UFS) standard. For example, as the communication standard of the communication path 3, a mobile industry processor interface (MIPI) M-PHY can be employed. For example, as the communication standard through the communication path 3, a small computer system interface (SCSI) can be employed.

The memory system 2 functions as an external storage device of the host 1. For example, the host 1 maps a storage area of the memory system 2 into a logical address space. The host 1 can issue an access command that includes locational information that specifies a location in the logical address space of the memory system 2 when accessing the memory system 2. Types of the access command include read and write. The access command for read is written as read command. The access command for write is written as write command. The locational information that specifies a location in the logical address space of the memory system 2 is described as logical address. The logical address expresses a location in a logical block addressing (LBA), for example.

The host 1 includes a central processing unit (CPU) 11, a dynamic random access memory (DRAM) 12, and a host controller 13. The CPU 11, the DRAM 12, and the host controller 13 are mutually connected with a bus 14.

The DRAM 12 functions as a main memory of the host 1. As the main memory of the host 1, other types of memories can be also employed, other than the DRAM. The DRAM 12 includes a host area 121 and a device area 122.

The CPU 11 executes an operating system (OS) program and a user program while using the host area 121 as a work memory. For example, the OS program and the user program are stored in advance in the memory system 2 in a non-volatilized manner. The OS program is loaded onto the host area 121 as an OS program 128 at the time of boot of the host 1, and the CPU 11 executes the OS program 128 loaded on the host area 121. The CPU 11 can load the user program from the memory system 2 onto the host area 121 as a user program 130 in response to an instruction from an operator or the like. The CPU 11 then can execute the user program 130 loaded on the host area 121.

The CPU 11 is one of processing devices. In other words, the CPU 11 is a circuit that realizes functions based on and according to the programs. The CPU 11 realizes an OS function 111 by executing the OS program. Further, the CPU 11 realizes a user program function 112 by executing the user program. The OS function 111 provides, to the user program function 112, an environment where resources of the information processing apparatus 1000 can be used. The resources include the CPU 11, the DRAM 12, and the memory system 2, for example. The user program function 112 uses the OS function 111 through a system call, for example. The system call is an input/output function provided by the OS function 111 to the user program function 112. The system call is also called service call, kernel call, or supervisor call. Not only the user program function 112 but also the OS function 111 may call the system call.

Further, the CPU 11 functions as a device driver function 113 by executing a device driver program. The device driver function 113 provides a function to use the memory system 2. Details of the device driver function 113 will be described below.

Here, description will be given on the assumption that the device driver function 113 is included in the OS function 111. That is, the device driver program is loaded onto the host area 121 as a device driver program 129 that is a part of the OS program 128. The CPU 11 realizes the device driver function 113 by executing the device driver program 129 loaded on the host area 121. Note that the device driver function 113 may not be included in the OS function 111. The device driver program may be prepared as a program separated from the OS program and separately distributed from the OS program. The device driver program may be distributed by a manufacturer of the memory system 2. The device driver program may be included in the OS program. While description is given on the assumption that the device driver function 113 is realized by a program, a part or all of the device driver function 113 may be realized by a hardware circuit that does not require a program. Further, the device driver function 113 may be realized by a hardware circuit other than the CPU 11. Further, the device driver function 113 may be realized by cooperation of the CPU 11 and another hardware circuit. As described above, the hardware configuration of the circuit that realizes the device driver function 113 is not limited to a specific hardware configuration.

The host controller 13 executes data transfer under control of the CPU 11. Further, according to the UMA, the memory system 2 (more accurately, a device controller 22 described below) can issue a command for accessing the device area 122 in the DRAM 12, and the host controller 13 executes the data transfer in response to the command issued by the device controller 22.

The host controller 13 may include a processing device such as a CPU. The host controller 13 may include a direct memory access controller (DMAC). The host controller 13 may be configured from a hardware circuit that does not require a program. The host controller 13 may be realized by a combination of the processing device and the hardware circuit that does not require a program. That is, the hardware configuration of the host controller 13 is not limited to a specific hardware configuration.

The memory system 2 includes a NAND-type flash memory (NAND memory) 21 as a non-volatile memory and the device controller 22. Note that, as a non-volatile memory, types of memories other than the NAND-type flash memory can be employed. For example, a magnetoresistive random access memory (MRAM), a resistive random access memory (ReRAM), a NOR-type flash memory, or the like can be employed as the non-volatile memory.

In the NAND memory 21, user data 212 received from the host 1 is stored. The user data 212 includes, for example, the OS program that is the program that realizes the OS function 111, the user program that is the program that realizes the user program function 112, or data input/output to/from the OS function 111 or the user program function 112.

Further, the NAND memory 21 stores an L2P table 211. The L2P table 211 is information in which correspondence between locations (that is, logical addresses) in the logical address space, the locations being allocated by the host 1 to the memory system 2, and physical locations (physical addresses) in the NAND memory 21 is recorded. Note that one or both of the logical addresses and the physical addresses may not be recorded in the L2P table 211 as long as the L2P table 211 has a configuration from which the correspondence between the logical addresses and the physical addresses can be acquired. For example, in a case where locations of entries of the L2P table 211 are associated with the logical addresses, the logical addresses may not be explicitly recorded in the L2P table 211.

The device controller 22 executes control of the memory system 2 including transfer of the user data 212 between the host 1 and the NAND memory 21. Further, the device controller 22 can use the device area 122 of the DRAM 12 of the host 1 as a work memory.

That is, the device controller 22 can at least write data to the device area 122 and read data in the device area 122. To be specific, the device controller 22 can issue a write command for storing data to the device area 122. The host controller 13 transfers the data from the device controller 22 to the device area 122 in response to the write command issued by the device controller 22. Further, the device controller 22 can issue a read command for reading data from the device area 122. The host controller 13 transfers the data from the device area 122 to the device controller 22 in response to the read command issued by the device controller 22.

Further, the device controller 22 may issue a command to cause the host controller 13 to execute transfer of the user data between the host area 121 and the device area 122 in response to the read command or the write command from the CPU 11. The host controller 13 executes the transfer of the user data between the host area 121 and the device area 122 in response to the command from the device controller 22.

Note that processing by the CPU 11 (for example, the OS function 111 or the device driver function 113) may intervene in the data transfer based on the command from the device controller 22. For example, the CPU 11 may calculate a source or a destination of the data transfer in the host area 121 or the device area 122, and transmit a calculation result to the host controller 13.

The device controller 22 buffers the L2P table 211 to the device area 122, and uses the L2P table 211 buffered in the device area 122. Note that using the L2P table 211 includes referring to the entry of the L2P table 211, updating the entry of the L2P table 211, or both of them. When the entry of the L2P table 211 has been updated, the device controller 22 writes the updated entry to the NAND memory 21 at predetermined timing, and considers the entry before the update of the L2P table 211 in the NAND memory 21 to be invalid.

Note that the L2P table 211 may not be buffered to the device area 122.

Further, the device controller 22 temporarily buffers, to the device area 122, the user data 212 which has been requested by the write command of the host 1 to be written and which has been stored in the host area 121. For example, the device controller 22 may receive, in the device controller 22, the user data 212 which has been requested to be written, and transfer the received user data 212 to the device area 122. Alternatively, the device controller 22 may cause the host controller 13 to transfer, from the host area 121 to the device area 122, the user data 212 which has been requested to be written. The device controller 22 writes the user data 212 buffered in the device area 122 to the NAND memory 21 at predetermined timing. The device controller 22 updates the L2P table 211 when writing the user data 212 to the NAND memory 21. Updating the L2P table 211 includes, to be specific here, rewriting the L2P table 211 buffered in the device area 122.

Further, the device controller 22 may read, from the NAND memory 21, the user data 212 which has been requested by the read command of the host 1 to be read, and temporarily buffer the read user data 212 to the device area 122. In a case where the user data 212 which has been requested to be read is buffered in the device area 122, the device controller 22 causes the host controller 13 to transfer the user data 212 in the device area 122 to the host area 121. Alternatively, the device controller 22 reads the user data 212 buffered in the device area 122 to the device controller 22, and transmits the read user data 212 to the host 1.

To the device area 122, a data buffer 123 that is an area to which the user data 212 is buffered and an L2P buffer 125 that is an area to which the L2P table 211 is buffered are allocated as configurations to buffer the user data 212 and the L2P table 211. Allocation of the data buffer 123 is executed by the device controller 22, for example. Further, allocation of the L2P buffer 125 is executed by the device controller 22, for example.

Further, in the device area 122, one or more data buffer tags 124 are stored as tag information for identifying the user data 212 in the data buffer 123. Further, in the device area 122, one or more L2P buffer tags 126 are stored as tag information for identifying entries (hereinafter, L2P entries) of the L2P table 211 stored in the L2P buffer 125. Storage of the tags is executed by the device controller 22, for example.

Here, as an example, description will be given on the assumption that the data buffer 123 has a memory structure of a cache, and each of the data buffer tags 124 has a memory structure of a cache tag. An offset from a predetermined base address to the location of each of the data buffer tags 124 statically corresponds to a lower bits of the logical address, and a higher bits of the logical address may be recorded in each of the data buffer tags 124. Whether the user data 212 of a desired logical address is stored in the data buffer 123 can be determined based on whether a value recorded in the data buffer tag 124 stored in the location corresponding to the lower bits of the desired logical address and the higher bits of the desired logical address are matched. The value recorded in the data buffer tag 124 and the higher bits of the desired logical address being matched means that the user data 212 of the desired logical address exists in the data buffer 123. The value recorded in the data buffer tag 124 and the higher bits of the desired logical address being not matched means that the user data 212 of the desired logical address does not exist in the data buffer 123. An offset from a head location of the data buffer 123 to the location of each of the user data 212 in the data buffer 123 statically corresponds to lower bits of a corresponding logical address. Therefore, when the user data 212 of the desired logical address has been turned out to exist in the data buffer 123, a storage location of the user data 212 of the desired logical address in the data buffer 123 can be calculated based on the lower bits of the desired logical address and the head location of the data buffer 123.

Hereinafter, existence of the user data 212 in the data buffer 123 having been turned out based on the corresponding data buffer tag 124 is written as the logical address being hit. Non-existence of the user data 212 in the data buffer 123 having been turned out based on the corresponding data buffer tag 124 is written as the logical address being not hit.

Here, as for the L2P table 211, description will be given on the assumption that all of the L2P table 211 are buffered in the L2P buffer 125. That is, the corresponding L2P buffer tags 126 are stored in the device area 122 about the entries of the L2P table 211. Note that a part of the entries of the L2P table 211 may be buffered in the device area 122. Whether a desired entry of the L2P table 211 is buffered in the device area 122 can be determined by reference to the corresponding L2P buffer tag 126. The L2P buffer 125 may have a memory structure of a cache, and each of the L2P buffer tags 126 may have a memory structure of a cache tag.

Note that the corresponding data buffer tag 124 is updated in response to update of the user data 212 in the data buffer 123. Further, the corresponding L2P buffer tag 126 is updated in response to update of the L2P entry in the L2P buffer 125.

As a hardware configuration of the device controller 22, any configuration can be employed as long as the configuration can execute control. The device controller 22 includes a processing device such as a CPU, for example. Control of the device controller 22 is realized as the processing device executes a firmware program. The firmware program is stored in the NAND memory 21 in advance.

Alternatively, the device controller 22 may be configured from a hardware circuit that does not require a program. For example, the device controller 22 may include the DMAC. The device controller 22 may be configured from a combination of a processing device and a hardware circuit that does not require a program. The device controller 22 may include a register or a small memory that can be used as a work memory. That is, the hardware configuration of the device controller 22 is not limited to a specific configuration.

The information processing apparatus 1000 further includes a power supply circuit 4 and a power supply circuit 5. The hatched arrows illustrate power supply. The power supply circuit 4 is a circuit that generates power that drives the device controller 22. The device controller 22 is driven by the power supplied from the power supply circuit 4. The power supply circuit 5 is a circuit that generates power that drives the NAND memory 21. The NAND memory 21 is driven by the power supplied from the power supply circuit 5. The power supply circuit 4 and the power supply circuit 5 may generate the power by using power charged in a battery (not illustrated). The power supply circuit 4 and the power supply circuit 5 may generate the power by converting power supplied from an outside.

The power supply circuit 4 includes a switch that starts and stops the power supply to the device controller 22. Here, an operation of the switch of the power supply circuit 4 is executed by the OS function 111 and the device driver function 113, as an example. That is, the OS function 111 and the device driver function 113 can transmit a signal for operating the switch to the power supply circuit 4 through the host controller 13.

Further, the power supply circuit 5 includes a switch that starts and stops the power supply to the NAND memory 21. Here, an operation of the switch of the power supply circuit 5 is executed by the OS function 111 and the device driver function 113. The OS function 111 and the device driver function 113 can transmit a signal for operating the switch to the power supply circuit 5 through the host controller 13.

The OS function 111 can change at least a power mode of the memory system 2 to a 0 mWSleep mode. The 0 mWSleep mode is one of low power consumption modes, and is a power mode that allows the power consumption of the memory system 2 to become zero or nearly zero during the operation of the host 1. Here, as an example, in the 0 mWSleep mode, both of the device controller 22 and the NAND memory 21 are stopped. In the 0 mWSleep mode, both of the power supply circuit 4 and the power supply circuit 5 are kept to a state where the power supply is stopped.

Control of the power mode may be realized by the host controller 13, instead of the OS function 111. Further, both of the OS function 111 and the host controller 13 may execute the control of the power mode. Further, the host 1 may include a dedicated control unit for the control of the power mode. Further, the operations of the switches of the power supply circuits 4 and 5 may be executed by an element instead of the OS function 111 and the device driver function 113. Further, the power supply circuit 4 may be included in the memory system 2. Further, the power supply circuit 5 may be included in the memory system 2.

When the power mode of the memory system 2 is changed from a normal operation mode to the 0 mWSleep mode, the device controller 22 holds at least the data buffer 123 and the data buffer tags 124 in the device area 122 as they are. Further, the device controller 22 stores a device controller state 221 necessary for resuming to the device area 122 as a device controller state 127. The device controller state 221 includes, for example, volatile data in the device controller 22. When the device controller 22 includes a resistor or the volatile memory, data stored in the resister or the volatile memory corresponds to the volatile data. The device controller state 221 includes a part or all of the volatile data. Normally, the device controller state 221 is stored as a device controller state 213 in the NAND memory 21. The normal operation mode is a mode in which the device controller 22 is accessing the NAND memory 21, or a mode in which the device controller 22 is accessible to the NAND memory 21. In the normal operation mode, at least the power is supplied to the device controller 22 and the NAND memory 21. When the power mode of the memory system 2 is resumed from the 0 mWSleep mode, processing of recovering the data buffer 123 and the data buffer tags 124 to the device area 122 can be omitted. Further, the recovery of the device controller state 221 from the device area 122 is at a higher speed than the recovery from the normal NAND memory 21, and thus a time for the resume from the 0 mWSleep mode is shortened. Here, as an example, the device controller 22 holds, in the device area 122, not only the data buffer 123 and the data buffer tags 124, but also the L2P buffer 125 and the L2P buffer tags 126 as they are.

In the first embodiment, the host 1 can access the data buffer 123 without through the control of the memory system 2. The access to the data buffer 123 without through the control of the memory system 2 is realized by the device driver function 113. The device driver function 113 recognizes the head location of the data buffer 123 and the base address of the data buffer tag 124, and can read desired user data 212 from the data buffer 123 based on the head location, the base address, and the logical address. Further, as described above, while the power mode of the memory system 2 is the 0 mWSleep mode, the data buffer 123 and the data buffer tags 124 are held in the device area 122. Accordingly, the host 1 can read the desired user data 212 from the data buffer 123 while keeping the power mode of the memory system 2 to be the 0 mWSleep mode. In other words, the host 1 can use the device area 122 as a substitution for the memory system 2 while keeping the power mode of the memory system 2 to be the 0 mWSleep mode. Note that, when the power mode of the memory system 2 is not the 0 mWSleep mode, the host 1 does not access at least the data buffer 123.

Next, an operation of the information processing apparatus 1000 of the first embodiment will be described.

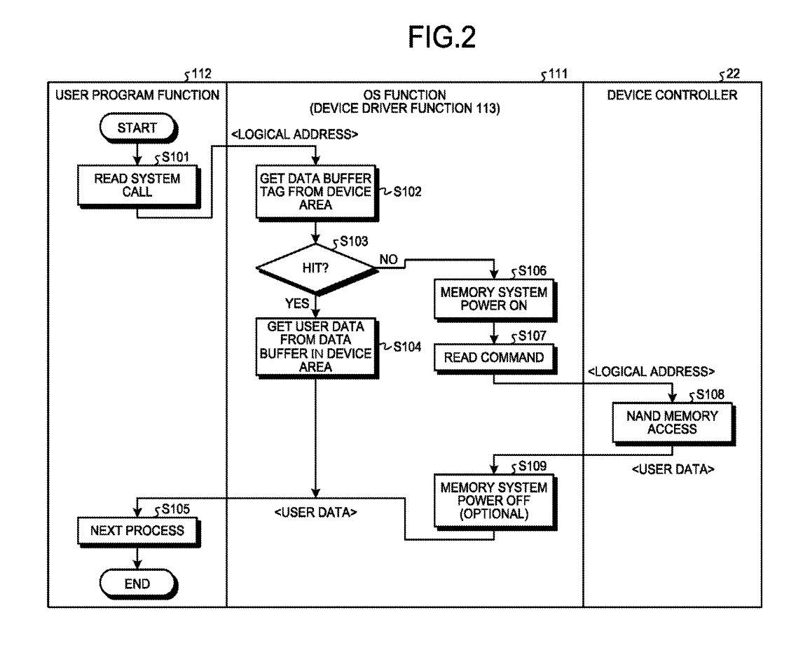

FIG. 2 is a flowchart illustrating an example of a read operation of the information processing apparatus 1000 of the first embodiment. In the description of FIG. 2, the user data 212 to be read is written as target user data 212. Here, a case of starting an operation of read when the power mode of the memory system 2 is the 0 mWSleep mode will be described.

In the case where the power mode of the memory system 2 is the 0 mWSleep mode, the power supply circuit 4 does not supply the power to the device controller 22, and the power supply circuit 5 does not supply the power to the NAND memory 21. When performing read of the user data 212, the user program function 112 calls a system call for read (READ System Call) (S101). When calling the READ System Call, the user program function 112 notifies the logical address that indicates the location of read. When the OS function 111 receives the logical address through the READ System Call, the device driver function 113 refers to the data buffer tag 124 corresponding to the logical address (S102). The data buffer tag 124 corresponding to the logical address is written as target data buffer tag 124. The device driver function 113 determines whether the logical address has been hit, based on the target data buffer tag 124 (S103).

When the logical address has been hit (Yes in S103), the device driver function 113 reads the target user data 212 from the data buffer 123 (S104), and transfers the target user data 212 to the user program function 112. The user program function 112 executes the next process using the target user data 212 (S105), and terminates the processing.

When the logical address has not been hit (No in S103), the device driver function 113 turns ON the power of the memory system 2 (S106). To be specific, the device driver function 113 causes the power supply circuit 4 and the power supply circuit 5 to start the power supply. Accordingly, the power mode of the memory system 2 is resumed to the normal operation mode. After the memory system 2 becomes a command-executable state, the device driver function 113 issues the read command to the memory system 2 (S107). For example, the device driver function 113 issues the read command conforming to the SCSI standard. The read command includes the logical address that indicates the location of read.

In the memory system 2, when the device controller 22 has received the read command, the device controller 22 executes an access to the NAND memory 21 and reads the target user data 212 (S108).

The processing of S108 is executed as follows, for example. The device controller 22 refers to the target data buffer tag 124 in the device area 122 through the host controller 13. The device controller 22 then determines whether the logical address has been hit, based on the target data buffer tag 124. Since the logical address is not hit, the device controller 22 refers to the L2P buffer tag 126 corresponding to the logical address through the host controller 13. The device controller 22 then reads the L2P entry from the L2P butter 125 through the host controller 13. The device controller 22 then translates the logical address into a physical address using the read L2P entry. The device controller 22 then reads the target user data 212 from the location of the NAND memory 21, the location being indicated by the physical address obtained by the translation.

When the L2P buffer 125 buffers a part of the L2P table 211, there is a case where an target L2P entry is not buffered to the L2P buffer 125. Whether the target L2P entry is buffered in the L2P buffer 125 can be determined by reference to the L2P buffer tag 126. When the target L2P entry is not buffered in the L2P buffer 125, the device controller 22 reads the target L2P entry from the NAND memory 21.

The device controller 22 transmits the target user data 212 read from the NAND memory 21 to the host 1. When having received the target user data 212 from the NAND memory 21, the device driver function 113 stops the power supply to the memory system 2 (S109), and transfers the received target user data 212 to the user program function 112.

In S109, the device driver function 113 stops the power supply to the device controller 22 and the NAND memory 21. The device driver function 113 may change the power mode of the memory system 2 to the 0 mWSleep mode in the processing of S109. Alternatively, the device driver function 113 may stop only the power supply to the NAND memory 21 in the processing of S109. Alternatively, the device driver function 113 may change the power mode of the memory system 2 to a power-saving mode other than the 0 mWSleep mode in the processing of S109.

The user program function 112 executes the next process using the received target user data 212 (S105), and terminates the processing.

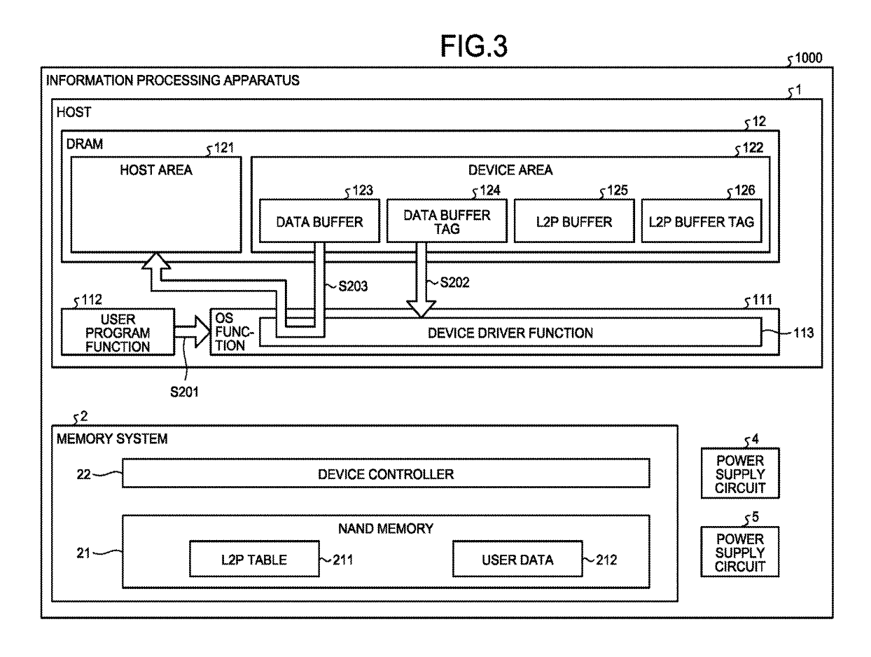

FIG. 3 is a diagram for describing a flow of data of when the logical address is hit in the operation of read of the first embodiment. When the user program function 112 calls the READ System Call (S201), the device driver function 113 refers to the target data buffer tag 124 (S202). When the logical address has been hit, the device driver function 113 transfers the target user data 212 from the data buffer 123 to the host area 121 (S203). In a case where the host controller 13 includes the DMAC, the host controller 13 may execute data transfer from the target data buffer 123 to the host area 121 under control of the device driver function 113. The user program function 112 can use the target user data 212 in the host area 121.

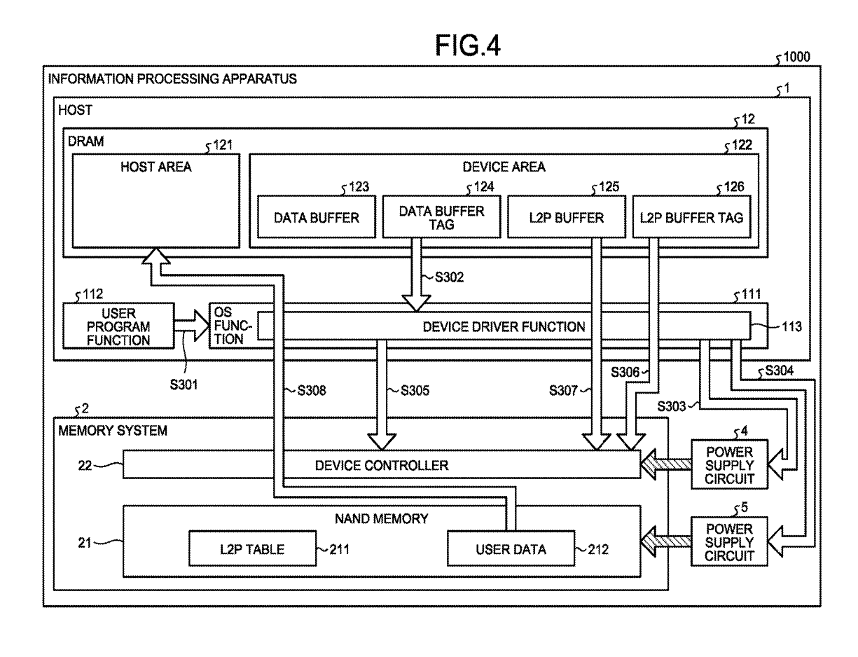

FIG. 4 is a diagram for describing data and a flow of a signal in a case where the logical address is not hit in the operation of read of the first embodiment. When the user program function 112 calls the READ System Call (S301), the device driver function 113 refers to the target data buffer tag 124 (S302). The logical address is not hit. The device driver function 113 causes the power supply circuit 4 and the power supply circuit 5 to start the power supply by transmitting the signal to the power supply circuit 4 and the power supply circuit 5 (S303 and S304). The device driver function 113 then transmits the read command to the memory system 2 (S305). The device controller 22 refers to the L2P buffer tag 126 (S306), and acquires the L2P entry from the L2P buffer 125 (S307). The device controller 22 then translates the logical address into a physical address by reference to the L2P entry. The device controller 22 then reads the target user data 212 from the location indicated by the physical address obtained by the translation, and transmits the read target user data 212 to the host 1 (S308). In 3308, the device controller 22 causes the host controller 13 to transfer the target user data 212 to the host area 121, for example.

Note that the device controller 22 may temporarily store the target user data 212 to the data buffer 123 in the processing of S308. The device controller 22 may cause the host controller 13 to transfer the user data 212 stored in the target data buffer 123 to the host area 121. When temporarily storing the target user data 212 to the data buffer 123, the device controller 22 updates the corresponding data buffer tag 124. Further, when the data buffer 123 overflows due to the storage of the target user data 212 to the data buffer 123, the device controller 22 may evict the overflow user data 212 to the NAND memory 21.

In the host 1, after receiving the target user data 212, the device driver function 113 can change the power mode of the memory system 2 to a power-saving mode (for example, the 0 mWSleep mode).

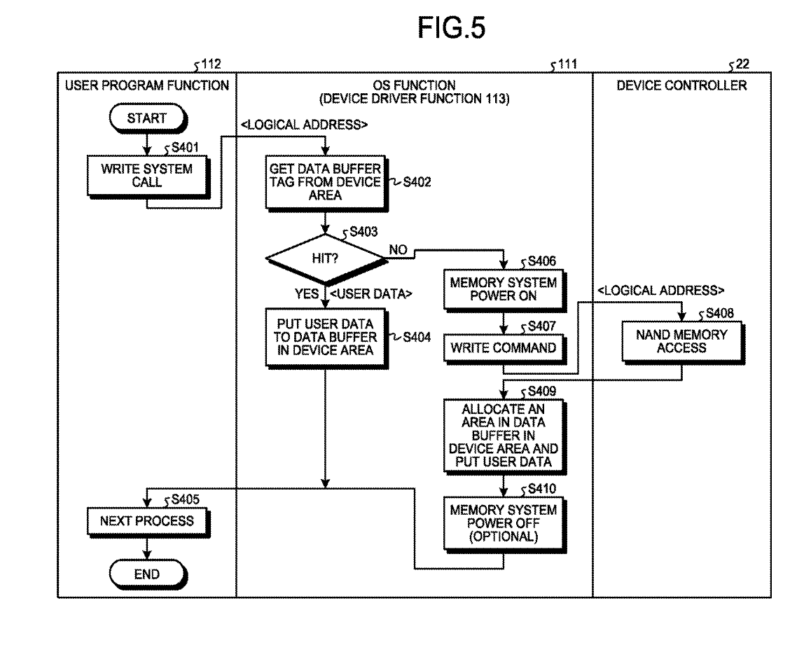

Note that the host 1 may be configured to be able to write the desired user data 212 to the data buffer 123 while keeping the power mode of the memory system 2 to be the 0 mWSleep mode. FIG. 5 is a flowchart illustrating an example of a write operation of the information processing apparatus 1000 of the first embodiment. In the description of FIG. 5, the user data 212 to be written is written as target user data 212.

The user program function 112 calls a system call for write (WRITE System Call) when performing write of the user data 212 (S401). When calling the WRITE System Call, the user program function 112 notifies the logical address that indicates the location of write. When the OS function 111 has received the logical address through the WRITE System Call, the device driver function 113 refers to the data buffer tag 124 corresponding to the logical address (S402). The data buffer tag 124 corresponding to the logical address is written as target data buffer tag 124. The device driver function 113 determines whether the logical address has been hit, based on the target data buffer tag 124 (S403).

When the logical address has been hit (Yes in S403), the device driver function 113 writes the target user data 212 to the location corresponding to the logical address in the data buffer 123 (S404). A result of write is notified to the user program function 112, and the user program function 112 executes next process (S405) and terminates the processing. The user program function 112 may not execute the next process.

When the logical address has not been hit (No in S403), the device driver function 113 turns ON the power of the memory system 2 (S406). To be specific, the device driver function 113 causes the power supply circuit 4 and the power supply circuit 5 to start the power supply. Accordingly, the power mode of the memory system 2 is resumed to the normal operation mode. After the memory system 2 becomes the command-executable state, the device driver function 113 issues the write command to the memory system 2 (S407). For example, the device driver function 113 issues the write command conforming to the SCSI standard. The write command includes the logical address that indicates the location of write.

In the memory system 2, when having received the write command, the device controller 22 executes an access to the NAND memory 21 in response to the write command (S408).

The processing of S408 is executed as follows, for example. The device controller 22 determines whether the logical address included in the write command is hit, by reference to the target data buffer tag 124 in the device area 122 through the host controller 13. The logical address is not hit, and thus the device controller 22 evicts arbitrary user data 212 in the data buffer 123 from the data buffer 123 in order to generate, in the data buffer 123, a free area (AREA) for the target user data 212. Here, the data buffer 123 has a memory structure of a cache, and thus the device controller 22 transfers the user data 212 stored in the location corresponding to lower bits of the logical address that indicates the location of write to the NAND memory 21 in order to generate the free area in the location corresponding to the lower bits of the logical address that indicates the location of write. The device controller 22 updates the L2P table 211 in response to the transfer of the user data 212 to the NAND memory 21. After the transfer of the user data 212 to the NAND memory 21, the device controller 22 recognizes the location of a transfer source of the user data 212 as the AREA.

After the processing of S408, the device driver function 113 allocates the generated free area to the target user data 212, and writes the target user data 212 to the allocated free area (S409). The device driver function 113 then stops the power supply to the memory system 2 (S410). A result of write is notified to the user program function 112, and the user program function 112 can execute the processing of S405.

In the processing of S410, the device driver function 113 stops the power supply to the device controller 22 and the NAND memory 21. Further, in the processing of S410, the device driver function 113 may change the power mode of the memory system 2 to the 0 mWSleep mode. Alternatively, in the processing of S410, the device driver function 113 may stop only the power supply to the NAND memory 21. Alternatively, in the processing of S410, the device driver function 113 may change the power mode of the memory system 2 to a power-saving mode other than the 0 mWSleep mode.

In the above description, the data buffer 123 has been described to have a memory structure of a cache. However, the structure of the data buffer 123 is not limited to the memory structure of a cache. The data buffer 123 may have a memory structure that can simply hold data, such as a first-in first-out (FIFO) structure.

When the data buffer 123 has the memory structure that can simply hold data, the correspondence between the user data 212 and the logical address stored in the data buffer 123 can be managed by an arbitrary method. For example, the location of the corresponding user data 212 in the data buffer 123 is recorded to each of the data buffer tags 124. That is, determination as to whether the user data 212 of the desired logical address exists in the data buffer 123, and acquisition of the location where the user data 212 of the desired logical address exists in a case where the user data 212 of the desired logical address exists in the data buffer 123 are executable based on the corresponding data buffer tag 124.

Further, when the data buffer 123 has the memory structure that can simply hold data, the configuration of the data buffer tag 124 for enabling determination as to whether each of the user data 212 exists in the data buffer 123 is not limited to a specific configuration. For example, whether the corresponding user data 212 exists in the data buffer 123 is recorded to each of the data buffer tags 124. Further, the data buffer tag 124 corresponding to the user data 212 that exists in the data buffer 123 exists in the device area 122, and the data buffer tag 124 corresponding to the user data 212 that does not exist in the data buffer 123 does not exist in the device area 122.

Further, the data buffer tags 124 each corresponding to each logical address in the entire logical address space in the memory system 2 can be stored in the device area 122. The data buffer tags 124 can be arranged in the device area 122 in an order of the logical addresses. Further, the data buffer tags 124 can be arranged in the device area 122 in an arbitrary order.

Further, in the case where the data buffer tags 124 are arranged in the device area 122 in an arbitrary order, logical addresses as search keys can be recorded to the data buffer tags 124, for example.

Further, in the case where the data buffer 123 has the memory structure that can simply hold data, instead of the memory structure of a cache, a condition for determining whether the device driver function 113 in the operation of write starts the power supply to the memory system 2 is not limited to whether the logical address has been hit.

For example, the device driver function 113 determines whether the free area exists in the data buffer 123. When the free area exists in the data buffer 123, the device driver function 113 writes the target user data 212 to the free area without starting the power supply to the memory system 2. When the free area does not exist in the data buffer 123, the device driver function 113 starts the power supply to the memory system 2, and transmits the write command to the memory system 2. The device controller 22 executes eviction of arbitrary user data 212 in the data buffer 123 in response to the write command.

Alternatively, when clean user data 212 is stored in the data buffer 123, the device driver function 113 may generate the free area by deleting the clean user data 212. Alternatively, the device driver function 113 may write the target user data 212 over the clean user data 212. The “clean” means a state in which content of the user data 212 in the data buffer 123 and content of the user data 212 in the NAND memory 21 are matched. A state in which the content of the user data 212 in the data buffer 123 and the content of the user data 212 in the NAND memory 21 are not matched is written as dirty. Each of the data buffer tags 124 may include information that indicates whether the corresponding user data 212 is clean or dirty. The device driver function 113 records dirty to the corresponding data buffer tag 124 in accordance with storing of the target user data 212 to the location where the clean user data 212 has been stored. The information that indicates whether the user data 212 of the data buffer 123 is clean or dirty may be managed in the device area 122, separately from the data buffer tag 124.

Similarly to the data buffer 123, the structure of the L2P buffer 125 is not limited to the memory structure of a cache. The L2P buffer 125 may have a memory structure that can simply hold all of the L2P table data. In that case, the L2P buffer tags 126 are not necessarily required. Further, the L2P buffer 125 may have a memory structure that can simply hold data, such as a FIFO structure. In that case, information as to whether the L2P entry of the L2P tag is stored in the L2P buffer 125, and the location where the L2P entry is stored when the L2P entry is stored in the L2P buffer 125 may be held in the device area 122, instead of the L2P buffer tag 126.

Further, the power mode of the memory system 2 can be changed to another mode of the 0 mWSleep mode.

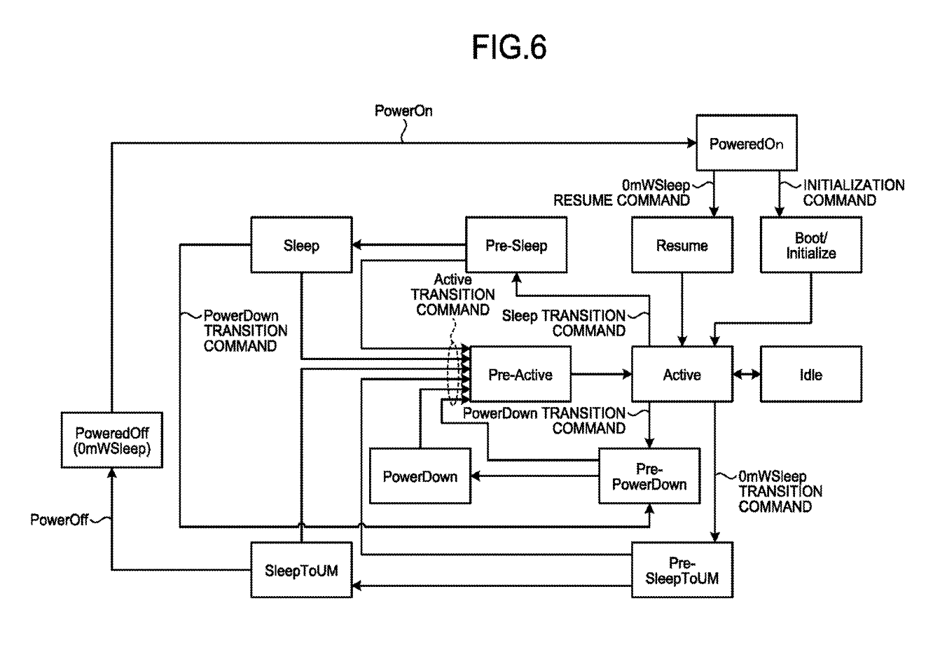

FIG. 6 is a diagram illustrating an example of a power mode group. An Active mode is a mode in which processing of the access command from the host 1 is being executed, or a mode in which background processing is being executed. The Active mode corresponds to the above-described normal operation mode. The power mode of the memory system 2 can be changed from the Active mode to a Sleep mode through a Pre-Sleep mode in response to a Sleep transition command from the host 1. The Sleep mode is one of low power consumption modes. In the Sleep mode, the memory system 2 can receive at least a Sleep resume command. That is, in the Sleep mode, the power is being supplied to at least a part of the device controller 22. Therefore, the power consumption in the Sleep mode is larger than the power consumption in the 0 mWSleep mode.

Further, the power mode of the memory system 2 can be changed from the Active mode to a PowerDown mode through a Pre-PowerDown mode in response to a PowerDown transition command from the host 1. The PowerDown mode is a power mode that can completely stop the power supply to the memory system 2. When stopping the power supply to the host 1 itself, the host 1 changes the power mode of the memory system 2 to the PowerDown mode as a part of a power off sequence. After the change of the power mode of the memory system 2 to the PowerDown mode, the host 1 stops the power supply to the memory system 2 and the power supply to the host 1 itself. The Pre-PowerDown mode is a power mode in which all of the device controller state 221 are saved to the NAND memory 21. Further, in the Pre-PowerDown mode, at least the dirty data in the device area 122 is saved to the NAND memory 21.

Note that the power mode of the memory system 2 can be changed from the PowerDown mode to the Active mode through a Pre-Active mode in response to an Active transition command from the host 1. That is, after the change of the power mode of the memory system 2 to the PowerDown mode, the host 1 can change the power mode of the memory system 2 to the Active mode, instead of stopping the power supply to the memory system 2. In the Pre-Active mode, the device controller 22 executes recovery of the device controller state 221 and recovery of the data in the device area 122. After completion of the recovery, the power mode of the memory system 2 is automatically changed from the Pre-Active mode to the Active mode.

Further, the power mode of the memory system 2 can be changed from the Active mode to the 0 mWSleep mode through a Pre-SleepToUM mode and a SleepToUM mode in response to a 0 mWSleep transition command from the host 1. In the Pre-SleepToUM mode, the device controller 22 executes saving of the device controller state 221. In the Pre-SleepToUM mode, the device controller state 221 is saved to the device area 122, for example. When the saving has been completed, the power mode of the memory system 2 is changed to the SleepToUM mode. The SleepToUM mode is a power mode that waits for stop of the power supply. The power mode of the memory system 2 is changed to the 0 mWSleep mode by the stop of the power supply.

Further, the power mode of the memory system 2 can be changed from the SleepToUM mode, the Pre-SleepToUM mode, the Sleep mode, the Pre-Sleep mode, or the Pre-PowerDown mode to the Active mode through the Pre-Active mode in response to the Active transition command from the host 1.

Further, the power mode of the memory system 2 can be changed from the Sleep mode to the PowerDown mode through the Pre-PowerDown mode in response to a PowerDown transition command from the host 1.

Further, the power mode of the memory system 2 can be changed from the 0 mWSleep mode to PoweredOn mode by start of the power supply to the memory system 2. The power mode of the memory system 2 is changed to the Active mode through Resume mode upon receiving a 0 mWSleep resume command in the PoweredOn mode. The device controller 22 executes recovery of the device controller state 221 in the Resume mode.

Further, the power mode of the memory system 2 can be changed from the PoweredOn mode to the Active mode through a Boot/Initialize mode in response to an initialization command from the host 1. In the Boot/Initialize mode, the device controller 22 executes recovery of the device controller state 221 from the NAND memory 21 or construction of the device controller state 221 by a method recorded in the NAND memory 21. The device controller 22 may execute any of portions according to the portions of the device controller state 221.

When the host 1 is started after a normal power off sequence, the host 1 transmits the initialization command to the memory system 2. Accordingly, the device controller 22 can execute the recovery of the device controller state 221 using the data saved to the NAND memory 21 in the Pre-PowerDown mode and the method recorded in the NAND memory 21. When changing the memory system 2 from the 0 mWSleep mode to the Active mode, the host 1 transmits the 0 mWSleep resume command to the memory system 2. Accordingly, the device controller 22 can execute the recovery of the device controller state 221 using the data saved to the device area 122.

Further, the power mode of the memory system 2 can be changed between the Active mode and an Idle mode. The Idle mode is a power mode in which the memory system 2 does not execute any processing although the power to the memory system 2 is being supplied similarly to the Active mode.

Note that paths of the transition among the power mode group and the power modes are not limited to the description of FIG. 6. An arbitrary power mode may be added or an arbitrary power mode may be deleted. Further, an arbitrary path may be added or an arbitrary path may be deleted.

As described above, according to the first embodiment, the device controller 22 can use the device area 122 as the buffer (data buffer 123) for transfer of the user data 212. The device driver function 113 can access the data buffer 123 in the device area 122 while the power mode of the memory system 2 is the 0 mWSleep mode. Accordingly, in a case where the user program function 112 needs to access the memory system 2 when the power mode of the memory system 2 is the 0 mWSleep mode, the information processing apparatus 1000 can realize the processing equivalent to an access to the memory system 2 without resuming the power mode of the memory system 2 to the normal operation mode.

Further, the data buffer tags 124 for identifying the user data 212 stored in the data buffer 123 are stored in the device area 122. Accordingly, the device driver function 113 can determine whether the desired user data 212 exists in the data buffer 123 while the power mode of the memory system 2 is the 0 mWSleep mode by reference to the corresponding data buffer tag 124. When the desired user data 212 has been determined to exist in the data buffer 123, the device driver function 113 can read the desired user data 212 from the data buffer 123 while keeping the power mode of the memory system 2 to be the 0 mWSleep mode.

Further, when the desired user data 212 has been determined not to exist in the data buffer 123, the device driver function 113 starts the power supply to the memory system 2, and transmits the read command to the memory system 2. In the memory system 2, the device controller 22 reads the user data 212 from the NAND memory 21 and transmits the user data 212 to the host 1 in response to the read command.

Note that device controller 22 maintains the data buffer 123 to be held in the device area 122 when the power mode of the memory system 2 is changed from the normal operation mode to the 0 mWSleep mode. Accordingly, the device driver function 113 can acquire the desired user data 212 without changing the power mode of the memory system 2 when the power mode of the memory system 2 is the 0 mWSleep mode.

Further, the device driver function 113 can determine whether the data buffer 123 is available for storing the desired user data 212 while the power mode of the memory system 2 is the 0 mWSleep mode by reference to the corresponding data buffer tag 124.

Further, when the data buffer 123 has been determined to be available for storing the desired user data 212, the device driver function 113 can write the desired user data 212 to the data buffer 123 while keeping the power mode of the memory system 2 to be the 0 mWSleep mode.

Further, when the data buffer 123 has been determined not to be available for storing the desired user data 212, the device driver function 113 starts the power supply to the memory system 2, and transmits the write command to the memory system 2.

### Second Embodiment

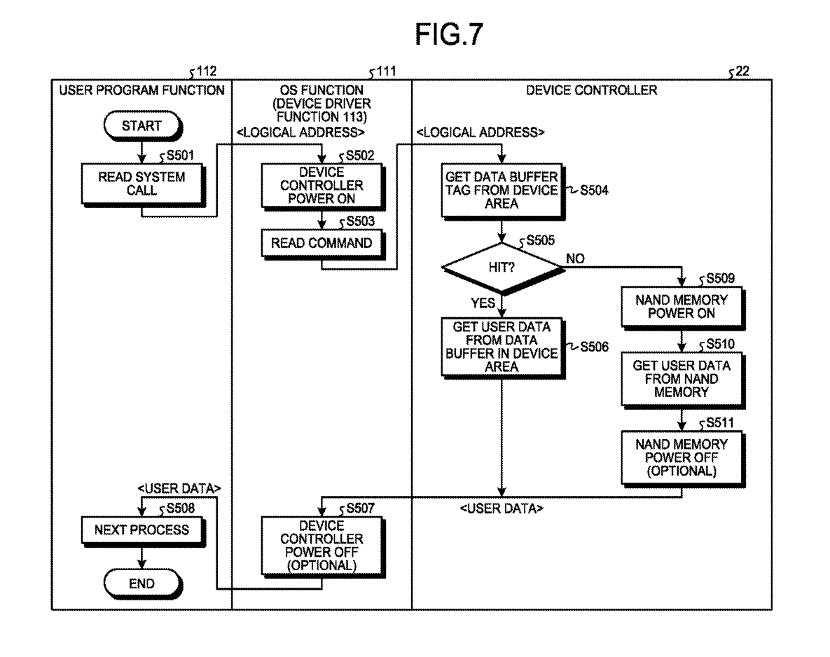

FIG. 7 is a flowchart illustrating an example of a read operation of an information processing apparatus 1000 according to a second embodiment. In the description of FIG. 7, user data 212 to be read is written as target user data 212.

First, a user program function 112 calls READ System Call (S501). When an OS function 111 has received a logical address through the READ System Call, a device driver function 113 starts power supply to a device controller 22 (S502). To be specific, the device driver function 113 causes a power supply circuit 4 to start the power supply. After a memory system 2 becomes a state in which the memory 2 can receive a command, the device driver function 113 issues a read command to the memory system 2 (S503). The read command includes the logical address that indicates the location of read.

In the memory system 2, when having received the read command, the device controller 22 accesses a device area 122, and refers to a data buffer tag 124 corresponding to the logical address included in the read command (S504). The data buffer tag 124 corresponding to the logical address is written as target data buffer tag 124. The device controller 22 determines whether the logical address has been hit based on the target data buffer tag 124 (S505).

When the logical address has been hit (Yes in S505), the device controller 22 reads the target user data 212 from a data buffer 123 (S506), and transmits the target user data 212 to a host 1. In the host 1, when having received the target user data 212, the device driver function 113 stops the power supply to the device controller 22 (S507), and transmits the received target user data 212 to the user program function 112. The user program function 112 executes the next process using the target user data 212 (S508), and terminates the processing.

When the logical address has not been hit (No in S505), the device controller 22 starts power supply to a NAND memory 21 (S509). To be specific, the device controller 22 transmits, to the host 1, a request for starting the power supply to the NAND memory 21, and a host controller 13 causes a power supply circuit 5 to start the power supply to the NAND memory 21 in response to receipt of the request. Note that in a case where the device controller 22 can operate a switch of the power supply circuit 5, the device controller 22 may cause the power supply circuit 5 to start the power supply to the NAND memory 21.

After the processing of S509, the device controller 22 executes an access to the NAND memory 21, and reads the target user data 212 (S510).

The processing of S510 is executed as follows, for example. The device controller 22 refers to an L2P buffer tag 126 corresponding to the logical address through the host controller 13. The device controller 22 then reads an L2P entry from an L2P buffer 125 through the host controller 13. The device controller 22 then translates the logical address into a physical address using the read L2P entry. The device controller 22 then reads the target user data 212 from the location of the NAND memory 21, the location being indicated by the physical address obtained by the translation.

When having received the target user data 212 from the NAND memory 21, the device controller 22 stops the power supply to the NAND memory 21 (S511). To be specific, the device controller 22 transmits, to the host 1, a request for stopping the power supply to the NAND memory 21, and the host controller 13 causes the power supply circuit 5 to stop the power supply to the NAND memory 21 in response to receipt of the request. In a case where the device controller 22 can operate a switch of the power supply circuit 5, the device controller 22 may cause the power supply circuit 5 to stop the power supply to the NAND memory 21.

The device controller 22 transmits the target user data 212 read from the NAND memory 21 to the host 1. When having received the target user data 212 from the NAND memory 21, the device driver function 113 stops the power supply to the memory system 2 (S507), and transfers the received target user data 212 to the user program function 112.

Note that the device controller 22 may not perform the processing of S511. Further, the device driver function 113 may not perform the processing of S507. Further, in the processing of S507, the device driver function 113 may change a power mode of the memory system 2 to 0 mWSleep mode. Alternatively, in the processing of S507, the device driver function 113 may change the power mode of the memory system 2 to a power-saving mode other than the 0 mWSleep mode.

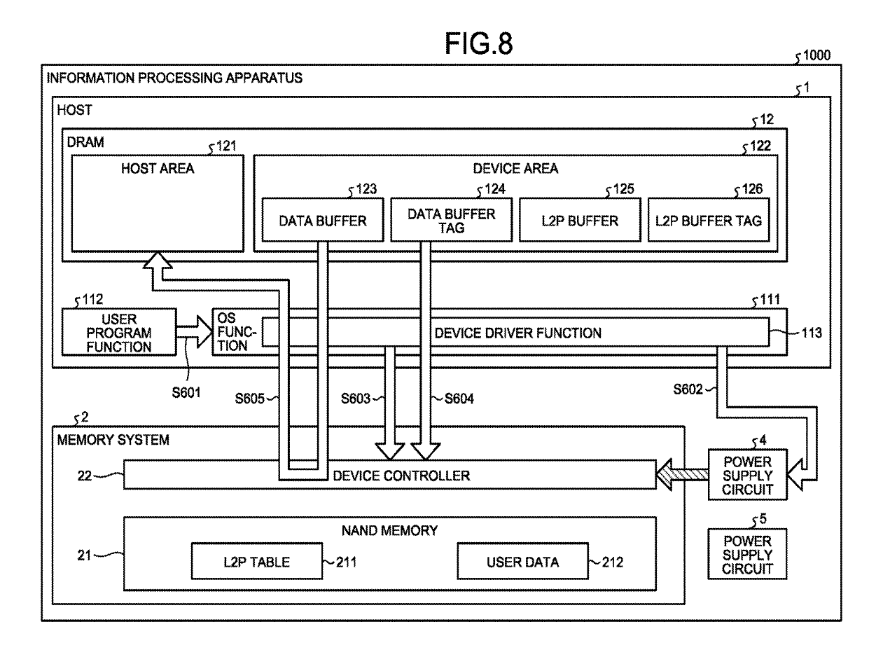

FIG. 8 is a diagram for describing data and a flow of a signal in a case where the logical address is hit in an operation of read of the second embodiment. When the user program function 112 calls the READ System Call (S601), the device driver function 113 starts the power supply to the power supply circuit 4 by transmitting a signal to the power supply circuit 4 (S602). The device driver function 113 then transmits a read command to the memory system 2 (S603).

When having received the read command, the device controller 22 refers to the target data buffer tag 124 (S604). The logical address is hit, and the device controller 22 reads the target user data 212 from the data buffer 123, and transfers the read target user data 212 to the host area 121 (3605). After receiving the target user data 212, the device driver function 113 can change the power mode of the memory system 2 to a power-saving mode (for example, the 0 mWSleep mode).

Note that, in the processing of 3605, the host controller 13 may transfer the target user data 212 from the data buffer 123 to the host area 121 under control of the device driver function 113. For example, the device controller 22 notifies the location of the target user data 212 in the data buffer 123 to the host controller 13, and the host controller 13 transfers the target user data 212 from the notified location to the host area 121.

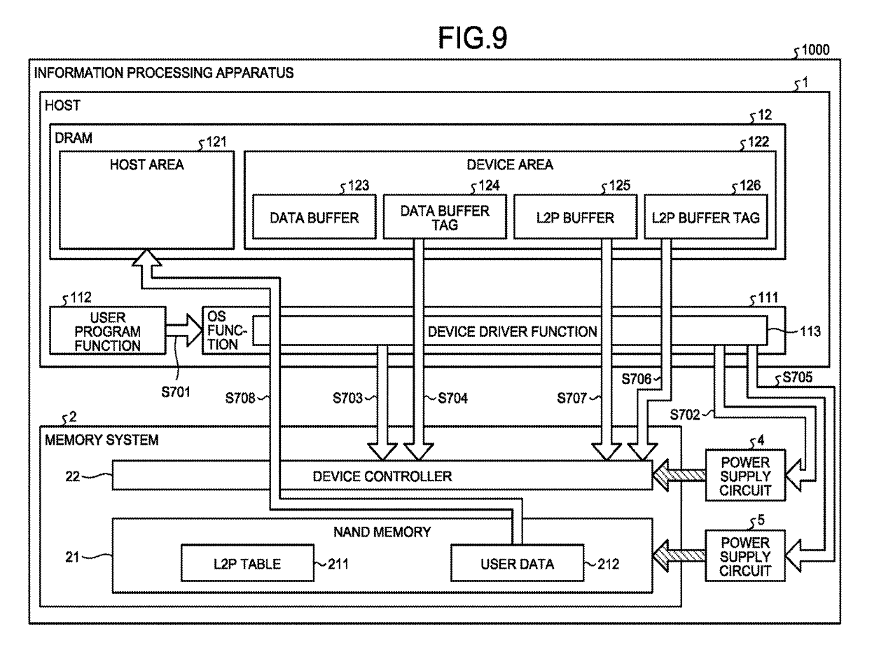

FIG. 9 is a diagram for describing data and a flow of a signal in a case where the logical address is not hit in an operation of read of the second embodiment. When the user program function 112 calls the READ System Call (S701), the device driver function 113 starts the power supply to the power supply circuit 4 by transmitting a signal to the power supply circuit 4 (S702). The device driver function 113 then transmits the read command to the memory system 2 (S703).

When having received the read command, the device controller 22 refers to the target data buffer tag 124 (S704). Since the logical address is not hit, the device controller 22 needs to access the NAND memory 21. The device driver function 113 starts the power supply to the power supply circuit 5 by transmitting a signal to the power supply circuit 5 (S705). The device controller 22 refers to the L2P buffer tag 126 (S706), and acquires the L2P entry from the L2P buffer 125 based on a result of the reference (S707). The device controller 22 then translates the logical address into a physical address by reference to the L2P entry. The device controller 22 then reads the target user data 212 from the location indicated by the physical address obtained by the translation, and transmits the read target user data 212 to the host 1 (S708). In S708, to be specific, the device controller 22 transfers the target user data 212 to the host area 121 by controlling the host controller 13.

Note that, in the processing of S708, the device controller 22 may temporarily store the target user data 212 to the data buffer 123. The device controller 22 may transfer the user data 212 stored in the target data buffer 123 to the host area 121 by controlling the host controller 13. When temporarily storing the target user data 212 to the data buffer 123, the device controller 22 updates the data buffer tag 124. Further, in a case where the data buffer 123 overflows due to the storage of the target user data 212 to the data buffer 123, the device controller 22 may evict the overflow user data 212 to the NAND memory 21.

In the host 1, after the user data 212 is stored in the host area 121 or the data buffer 123, the device driver function 113 can change the power mode of the memory system 2 to a power-saving mode (for example, the 0 mWSleep mode).

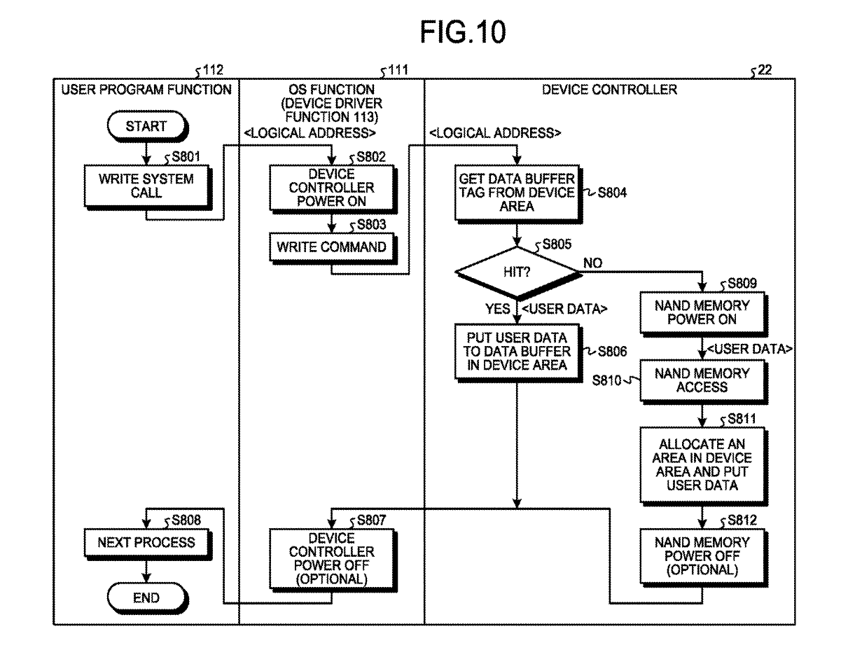

FIG. 10 is a flowchart illustrating an example of an operation of the information processing apparatus 1000 of the second embodiment at the time of write. In the description of FIG. 10, the user data 212 to be written is written as target user data 212.

First, the user program function 112 calls WRITE System Call (S801). When calling the WRITE System Call, the user program function 112 notifies the logical address that indicates the location of write. When the OS function 111 has received the logical address through the WRITE System Call, the device driver function 113 starts the power supply to the device controller 22 (S802). After the memory system 2 becomes a state in which the memory system 2 can receive a command, the device driver function 113 issues a write command to the memory system 2 (S803). The write command includes the logical address that indicates the location of write.

In the memory system 2, when having received the write command, the device controller 22 accesses the device area 122, and refers to the data buffer tag 124 corresponding to the logical address included in the write command (S804). The data buffer tag 124 corresponding to the logical address is written as target data buffer tag 124. The device controller 22 determines whether the logical address has been hit based on the target data buffer tag 124 (S805).

When the logical address has been hit (Yes in S805), the device controller 22 writes the target user data 212 to the location corresponding to the logical address in the data buffer 123 (S806). When the write has been completed, the device driver function 113 stops the power supply to the device controller 22 (S807), and transmits a notification of a result of the write to the user program function 112. The user program function 112 receives the notification of a result of the write, executes the next process (S808), and terminates the processing. The user program function 112 may not execute the next process.

When the logical address has not been hit (No in S805), the device controller 22 starts the power supply to the NAND memory 21 (S809). The device controller 22 then generates a free area (AREA) in the device area 122 by executing an access to the NAND memory 21 in response to the write command (S810).

The processing of S810 is executed as follows, for example. The device controller 22 evicts arbitrary user data 212 from the data buffer 123. Here, the data buffer 123 has a memory structure of a cache, and thus the device controller 22 transfers, to the NAND memory 21, the user data 212 stored in the location corresponding to lower bits of the logical address that indicates the location of write in order to generate the AREA. The device controller 22 updates an L2P table 211 in response to the transfer of the user data 212 to the NAND memory 21. After the transfer of the user data 212 to the NAND memory 21, the device controller 22 recognizes the location of a transfer source of the user data 212 as the AREA.

The device controller 22 allocates the generated free area (AREA) to the target user data 212, and writes the target user data 212 to the AREA (S811). The device controller 22 then stops the power supply to the NAND memory 21 (S812). The device controller 22 may execute the processing of S812 before the processing of 3811. When the write has been completed, the device driver function 113 stops the power supply to the device controller 22 (S807).

Note that the device driver function 113 may hold the target user data 212 in the host area 121 and keep the target user data 212 not transmitted to the memory system 2, and the device controller 22 may cause the host controller 13 to transfer the target user data 212 from the host area 121 to the data buffer 123 in the device area 122 in the processing of S806 or the processing of S811.

Alternatively, the device driver function 113 may transmit the target user data 212 to the memory system 2, and the device controller 22 may write the received target user data 212 to the data buffer 123 in the device area 122 in the processing of S806 or the processing of S811.

Further, the device controller 22 may not perform the processing of S812. Further, the device driver function 113 may not perform the processing of S807. Further, in the processing of S807, the device driver function 113 may change the power mode of the memory system 2 to the 0 mWSleep mode. Alternatively, in the processing of S807, the device driver function 113 may change the power mode of the memory system 2 to a power-saving mode other than the 0 mWSleep mode.

Further, as data structures of the data buffer 123, the data buffer tag 124, the L2P buffer 125, and the L2P buffer tag 126, arbitrary data structures can be employed, similarly to the first embodiment.

Further, the power mode of the memory system 2 may be able to be changed to another mode of the 0 mWSleep mode, similarly to the first embodiment.

As described above, when necessity to access the memory system 2 is caused in a case where the power mode of the memory system 2 is the 0 mWSleep mode, the device driver function 113 first causes the power supply circuit 4 to start the power supply to the device controller 22, and transmits an access command to the memory system 2. The device controller 22 can process the access command by using the data buffer 123 during stop of the power supply to the NAND memory 21. That is, an access to the memory system 2 can be realized without starting the power supply to the NAND memory 21.

Further, the data buffer tags 124 for identifying the user data 212 stored in the data buffer 123 are stored in the device area 122. Accordingly, the device controller 22 can determine whether the user data 212 to be read exists in the data buffer 123 by reference to the corresponding data buffer tag 124 without starting the power supply to the NAND memory 21. When having determined that the desired user data 212 exists in the data buffer 123, the device controller 22 can read the user data 212 to be read from the data buffer 123 without starting the power supply to the NAND memory 21.

Further, when having determined that the desired user data 212 does not exist in the data buffer 123, the device controller 22 starts the power supply to the memory system 2, and reads the user data 212 to be read from the NAND memory 21.

Note that the device controller 22, the device driver function 113, and the OS function 111 keep the data buffer 123 held in the device area 122 when the power mode of the memory system 2 is changed from the normal operation mode to the 0 mWSleep mode. Accordingly, the device controller 22 can acquire the user data 212 to be read without starting the power supply to the NAND memory 21.

Further, the device controller 22 can determine whether the data buffer 123 is available for storing the user data 212 to be written without starting the power supply to the NAND memory 21, by reference to the corresponding data buffer tag 124.

Further, when the data buffer 123 has been determined to be available for storing the user data 212 to be written, the device controller 22 can write the user data 212 to be written to the data buffer 123 without starting the power supply to the NAND memory 21.

Further, when the data buffer 123 has been determined not to be available for storing the user data 212 to be written, the device controller 22 starts the power supply to the NAND memory 21, and executes an access to the NAND memory 21.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a host device including a volatile first memory and a first control circuit;
a memory system including a non-volatile second memory in which user data is stored and a second control circuit that executes transfer of the user data between the host device and the second memory; and
a power supply circuit, wherein
the first memory includes an area, the area being used by the second control circuit,
the second control circuit uses the area as a buffer for the transfer, and
the first control circuit causes the power supply circuit to start and stop the power supply to the memory system and accesses, while the power supply to the memory system is stopped, the buffer.

2. The information processing apparatus according to claim 1, wherein
the second control circuit stores, to the area, tag information for identifying first user data, the first user data being user data stored in the buffer, and
the first control circuit determines, while the power supply to the memory system is stopped, whether second user data is the first user data based on the tag information, the second user data being user data to be read.

3. The information processing apparatus according to claim 2, wherein
in a case where the second user data is the first user data, the first control circuit reads the second user data from the buffer.

4. The information processing apparatus according to claim 2, wherein
in a case where the second user data is not the first user data, the first control circuit causes the power supply circuit to start the power supply to the memory system and transmits, to the memory system, a read command for reading the second user data.

5. The information processing apparatus according to claim 4, wherein
the second control circuit reads the second user data from the second memory in response to the read command, and transmits the read second user data to the host device.

6. The information processing apparatus according to claim 1, wherein
the second control circuit does not delete the buffer from the area, when the power supply circuit stops the power supply to the memory system.

7. The information processing apparatus according to claim 2, wherein
the tag information indicates correspondence between the first user data and a logical address of the first user data, and
the first control circuit determines whether the second user data is the first user data by searching for the tag information using a logical address of the second user data.

8. The information processing apparatus according to claim 1, wherein
the second control circuit stores, to the area, tag information for identifying first user data, the first user data being user data stored in the buffer, and
the first control circuit determines, while the power supply to the memory system is stopped, whether the buffer is available for storing second user data based on the tag information, the second user data being user data to be written.

9. The information processing apparatus according to claim 8, wherein
in a case where the buffer is available, the first control circuit writes the second user data to the buffer.

10. The information processing apparatus according to claim 8, wherein
in a case where the buffer is not available, the first control circuit causes the power supply circuit to start the power supply to the memory system and transmits, to the memory system, a write command.

11. The information processing apparatus according to claim 8, wherein
the tag information indicates correspondence between the first user data and a logical address of the first user data, and
the first control circuit
determines that the buffer is available, in a case where the logical address of the second user data is same as the logical address of the first user data, and
determines that the buffer is not available, in a case where the logical address of the second user data is not same as the logical address of the first user data.

12. An information processing apparatus comprising:
a host device including a volatile first memory and a first control circuit;
a memory system including a non-volatile second memory in which user data is stored, and a second control circuit that executes transfer of the user data between the host device and the second memory;
a first power supply circuit that starts and stops power supply to the second control circuit; and
a second power supply circuit that starts and stops power supply to the second memory, wherein
the first memory includes an area, the area being used by the second control circuit,
the second circuit uses the area as a buffer for the transfer, and
the first control circuit causes the first power supply circuit to start the power supply to the second control circuit and transmits an access command to the memory system, and the second control circuit, while the power supply to the second memory is stopped, processes the access command by using the buffer.

13. The information processing apparatus according to claim 12, wherein
the access command is a read command for reading first user data, the first user data being user data to be read, and
the second control circuit stores, to the area, tag information for identifying second user data, the second user data being user data stored in the buffer, and determines, while the power supply to the second memory is stopped, whether the first user data is the second user data based on the tag information.

14. The information processing apparatus according to claim 13, wherein
in a case where the first user data is the second user data, the second control circuit reads the first user data from the buffer.

15. The information processing apparatus according to claim 13, wherein
in a case where the first user data is the second user data, the second control circuit causes the second power supply circuit to start the power supply to the second memory and reads the first user data from the second memory.

16. The information processing apparatus according to claim 12, wherein
the second control circuit does not delete the buffer from the area when the first power supply circuit and the second power supply circuit stop the power supply.

17. The information processing apparatus according to claim 13, wherein
the tag information indicates correspondence between the second user data and a logical address of the second user data, and
the second control circuit determines whether the first user data is the second user data by searching for the tag information using a logical address of the first user data.

18. The information processing apparatus according to claim 12, wherein
the access command is a write command for writing first user data, the first user data being user data to be written,
the second circuit stores, to the area, tag information for identifying second user data, the second user data being user data stored in the buffer, and
the second circuit determines, while the power supply to the second memory is stopped, whether the buffer is available for storing the first user data based on the tag information.

19. The information processing apparatus according to claim 18, wherein
in a case where the buffer is available, the second circuit writes the first user data to the buffer.

20. The information processing apparatus according to claim 18, wherein
in a case where the buffer is not available, the second circuit causes the second power supply circuit to start the power supply to the second memory and moves the second user data from the buffer to the second memory.
